(19) United States
(12) Patent Application Publication
(10) Pub. No.: US 2017/0234197 A1
(43) Pub. Date: Aug. 17, 2017

(54) VEHICLE OXIDATION CATALYST DIAGNOSTIC STRATEGY

(71) Applicant: GM GLOBAL TECHNOLOGY OPERATIONS LLC, Detroit, MI (US)

(72) Inventor: Charles E. Dean, Clarkston, MI (US)

(73) Assignee: GM GLOBAL TECHNOLOGY OPERATIONS LLC, Detroit, MI (US)

(21) Appl. No.: 15/042,659

(22) Filed: Feb. 12, 2016

(51) Int. Cl. F01N 9/00; F01N 11/00; F01N 3/10; B01D 53/94; F01N 3/023

(52) U.S. Cl. CPC F01N 9/002; B01D 53/944; B01D 53/9495; F01N 3/0234; F01N 3/103; F01N 11/002; F01N 2550/02; F01N 2900/1602

(57) ABSTRACT

A system and method for diagnosing the oxidation catalyst of a vehicle includes an engine, an exhaust system in fluid communication with an exhaust port of the engine and an oxidation catalyst connected with the engine via the exhaust port to receive an exhaust stream from the engine. A controller is operable to determine the operating state of the engine and vehicle, calculate a heat release value for the oxidation catalyst and determine an ideal heat release value. The controller will determine the oxidation catalyst efficiency by calculating a ratio of the heat release value to the ideal heat release value.

### TECHNICAL FIELD

The present invention relates to oxidation catalyst systems of the type used aboard a vehicle.

### BACKGROUND

Internal combustion engines generally include an exhaust after-treatment device, such as diesel particulate filters, three-way catalysts, and the like. The exhaust after-treatment devices have been developed to effectively limit exhaust emissions from internal combustion engines. In the case of compression-ignition or diesel engines, a great deal of effort continues to be expended to develop practical and efficient devices and methods for reducing emissions of largely carbonaceous particulates in exhaust gases. An oxidation catalyst is one of the devices that are often provided in diesel engines for such a purpose.

Typical exhaust systems incorporate an oxidation catalyst to reduce emissions from diesel engine. The oxidation catalyst oxidizes hydrocarbons (HC) and carbon monoxides (CO) that are formed in the combustion process of the engine. During its operative life, oxidation catalysts gradually reduce their efficiency. Diagnostic systems incorporated in a vehicle may be used to determine the efficiency index of the oxidation catalyst during an exhaust system regeneration process. However, the diagnostic system may be unable to differentiate whether an oxidation catalyst is operating below normal operating parameters during the regeneration process.

### SUMMARY

A system and method for diagnosing the oxidation catalyst of a vehicle includes an engine, an exhaust system in fluid communication with an exhaust port of the engine and an oxidation catalyst connected with the engine via the exhaust port to receive an exhaust stream from the engine. A controller is operable to calculate a heat release value for the oxidation catalyst and determine an ideal heat release value. The controller will determine the oxidation catalyst efficiency by calculating a ratio of the heat release value to the ideal heat release value.

At least one sensor may be provided that is in communication with the controller and configured to measure the exhaust gas temperature upstream of the diesel oxidation catalyst while another at least one sensor may be in communication with the controller and configured to measure the exhaust gas temperature downstream of the oxidation catalyst. The controller is operable to calculate the heat release value by determining an exhaust gas mass flow rate into the oxidation catalyst, calculating a catalyst value from the product of the exhaust gas mass flow rate and the difference between the exhaust gas temperature downstream of the oxidation catalyst and an inert temperature, and integrating the catalyst value to determine the heat release value.

In one embodiment of the disclosure, the controller evaluates a temperature model to determine the inert temperature used to calculate the specific heat value. The controller may be configured to compare the efficiency index with a preset threshold beneath which the oxidation catalyst is considered faulty. The engine of the vehicle may be a diesel engine and the exhaust system may include a particulate filter in fluid communication with an outlet side of and downstream of the oxidation catalyst and regenerable using heat from the oxidation catalyst.

In another embodiment of the disclosure, a system for use aboard a vehicle having an engine comprises an exhaust system in fluid communication with an exhaust port of the engine and an oxidation catalyst connected with the engine via the exhaust port to receive an exhaust stream from the engine. The system may include a controller operable to calculate a heat release value for the oxidation catalyst, determine an ideal heat release value, and determine oxidation catalyst efficiency by calculating a ratio of the heat release value to the ideal heat release value.

At least one sensor may be provided that is in communication with the controller and configured to measure the exhaust gas temperature upstream of the diesel oxidation catalyst. At least one sensor may be in communication with the controller and configured to measure the exhaust gas temperature downstream of the oxidation catalyst.

The controller is operable to calculate the heat release value by determining an exhaust gas mass flow rate into the oxidation catalyst, calculating a catalyst value from the product of the exhaust gas mass flow rate and the difference between the exhaust gas temperature downstream of the oxidation catalyst and an inert temperature, and integrating the catalyst value to determine the heat release value. In one embodiment of the disclosure, the controller evaluates a temperature model to determine the inert temperature used to calculate the specific heat value.

The controller may be configured to compare the efficiency index with a preset threshold beneath which the oxidation catalyst is considered faulty. The engine of the vehicle may be a diesel engine and the exhaust system may include a particulate filter in fluid communication with an outlet side of and downstream of the oxidation catalyst and regenerable using heat from the oxidation catalyst.

In another embodiment of the disclosure, a method for determining the efficiency of an oxidation catalyst of an exhaust system aboard a vehicle is disclosed. The oxidation catalyst may be in fluid communication with an exhaust port of an engine and receive an exhaust stream from the exhaust port of the engine. A controller in communication with the oxidation catalyst, exhaust system and engine of the vehicle is provided and calculates a heat release value with the controller for the oxidation catalyst.

The controller determines an ideal heat release value and determines the oxidation catalyst efficiency by calculating a ratio of the heat release value to the ideal heat release value with the controller. A control action is executed aboard the vehicle via the controller using the oxidation catalyst efficiency to determine the effectiveness of the oxidation catalyst.

In one embodiment of the disclosure, the controller calculates a heat release value with the controller by determining an exhaust gas mass flow rate into the oxidation catalyst, calculating a catalyst value from the product of the exhaust gas mass flow rate and the difference between the exhaust gas temperature downstream of the oxidation catalyst and an inert temperature and integrating the catalyst value to determine the heat release value. The controller may evaluate a temperature model to determine the inert temperature used to calculate the specific heat value. The controller may compare the efficiency index with a preset threshold beneath which the oxidation catalyst is considered faulty.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an internal combustion engine and an oxidation catalyst system;

FIG. 2 is a flowchart describing a method for determining the efficiency of the oxidation catalyst of the exhaust system of the vehicle shown in FIG. 1;

FIG. 3 is a graphical illustration of the oxidation catalyst diagnostic of the disclosure where the oxidation catalyst operates within acceptable tolerance levels; and

FIG. 4 is a graphical illustration of the oxidation catalyst diagnostic of the disclosure where the oxidation catalyst operates outside of acceptable tolerance levels.

### DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

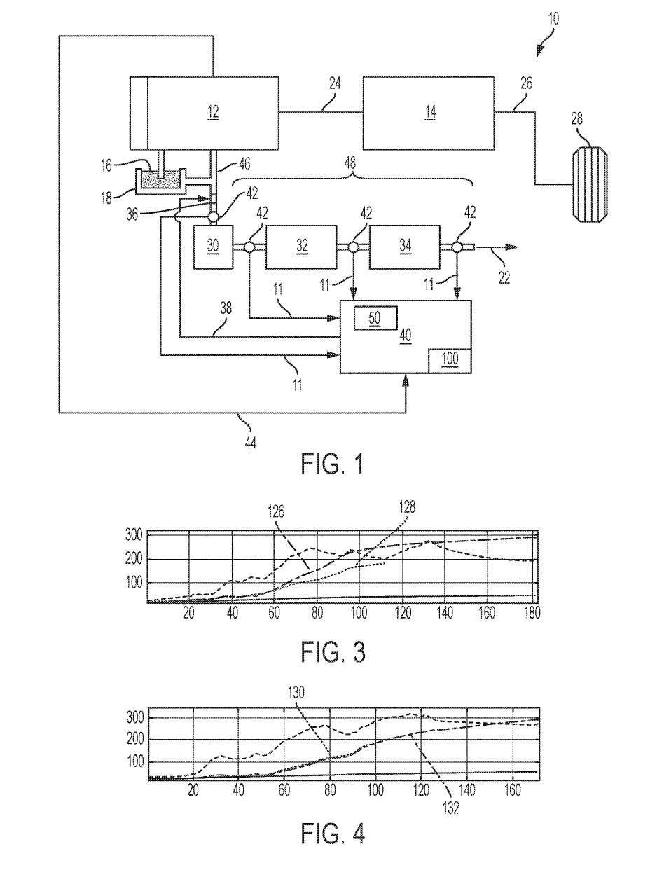

Referring to the drawings, wherein like reference numbers correspond to like or similar components throughout the several Figures, a vehicle 10 is shown schematically in FIG. 1. The vehicle 10 may include a motorized vehicle, such as, but not limited to, standard passenger cars, sport utility vehicles, light trucks, heavy duty vehicles, minivans, buses, transit vehicles, bicycles, robots, farm implements, sports-related equipment or any other transportation device. Vehicle 10 includes a controller 40 and a control system or diagnostic algorithm 100. Control system or algorithm 100 may be selectively executed by controller 40 in order to calculate the actual conversion efficiency of an oxidation catalyst (OC) system 48 aboard the vehicle 10.

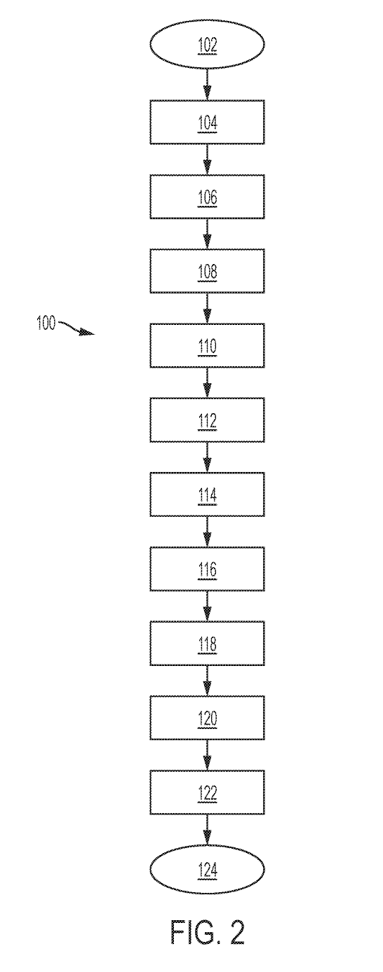

Controller 40 controls overall operation of the engine control system and is thus operable for calculating, evaluating, and controlling actual hydrocarbon levels ultimately discharged from the vehicle 10 into the surrounding atmosphere, doing so in part using an inert temperature model 50 as described in further detail below with reference to FIG. 2. The controller 40 may be configured to perform a plurality of engine system diagnostics and control engine system operations based upon various vehicle parameters including, but not limited to, driver input, stability control and the like. The controller may be implemented in an engine control module (ECM), a vehicle computer, or may be an independent controller.

Vehicle 10 includes an internal combustion engine 12, such as a diesel engine or a direct injection gasoline engine, the OC system 48, and a transmission 14. Engine 12 combusts fuel 16 drawn from a fuel tank 18. In one possible embodiment, the fuel 16 is diesel fuel, and the oxidation catalyst system 48 is a diesel oxidation catalyst (DOC) system, although other fuel types may be used depending on the design of the engine 12.

Combustion of fuel 16 generates an exhaust stream or flow 22, which is ultimately discharged from vehicle 10 into the surrounding atmosphere. Energy released by the combustion of fuel 16 produces torque on an input member 24 of the transmission 14. The transmission 14 in turn transfers the torque from engine 12 to an output member 26 in order to propel the vehicle 10 via a set of wheels 28, only one of which is shown in FIG. 1 for simplicity.

OC system 48 is in fluid communication with the exhaust port 46 of engine 12, such that the OC system receives and conditions a fluid in the form of a gaseous exhaust stream 22 as it passes in a gaseous or vapor fluidic state from the exhaust ports 46 of engine 12 through the vehicle exhaust system. OC system 48 includes an oxidation catalyst 30, an optional selective catalytic reduction (SCR) device 32, and a particulate filter 34. Particulate filter 34 may be configured as ceramic foam, metal mesh, pelletized alumina, or any other temperature and application-suitable material(s).

The term “condition” as employed above refers to temperature control and/or regulation of the exhaust stream 22 at various positions within the OC system 48. To that end, the particulate filter 34 is connected to or formed integrally with the oxidation catalyst 30. A fuel injection device 36 is in electronic communication with controller 40 via control signals 38, and is in fluid communication with the fuel tank 18. Fuel injection device 36 selectively injects fuel 16 into the oxidation catalyst 30 as determined by the controller 40. Fuel 16 injected into the oxidation catalyst 30 is burned therein in a controlled manner to generate heat sufficient for regenerating the particulate filter 34.

That is, oxidation catalyst 30 acts in the presence of a controlled temperature of exhaust stream 22 to oxidize or burn any hydrocarbons that are introduced into the exhaust stream. It is also understood that the oxidation catalyst may include zeolite content that may enable storage of increased amounts of hydrocarbons in the catalyst 30 for cold start conditions as will be described in greater detail below. This provides a sufficient temperature level in the particulate filter 34 for oxidizing particulate matter which has been trapped by the filter downstream of the oxidation catalyst 30. The particulate filter 34 is thus kept relatively free of potentially-clogging particulate matter.

Vehicle 10 includes the controller 40, which performs engine system diagnostics and monitors the ongoing operation of OC system 48 to ensure efficient hydrocarbon conversion. For example, the controller 40 verifies proper operation of the oxidation catalyst 30. Controller 40 calculates an actual conversion efficiency of the OC system 48, and uses this result to calculate actual hydrocarbon emissions from the OC system and determine whether the oxidation catalyst 30 is operating without fault. Controller 40 can then compare the results to a calibrated regulatory or other threshold and execute a control action to reflect the result as will be described in greater detail below.

Controller 40 may be configured as a digital computer acting as a vehicle controller, and/or as a proportional-integral-derivative (PID) controller device having a microprocessor or central processing unit (CPU), read-only memory (ROM), random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Control system or algorithm 100 and any required reference calibrations are stored within or readily accessed by controller 40 to provide the functions described below with reference to FIG. 2.

The controller may be in communication with an engine coolant sensor that generates a temperature signal based upon a temperature detected for the coolant fluid in the engine. The controller may also receive a temperature signal from an air temperature sensor that detects ambient temperature conditions for the environment in which the vehicle operates.

Controller 40 receives temperature signals 11 from various temperature sensors 42 positioned to measure exhaust temperatures at different locations within the OC system 48, including, but not limited to, directly upstream of the oxidation catalyst 30, directly downstream of the oxidation catalyst 30 and directly upstream of the particulate filter 34. In one embodiment, a temperature sensor 42 is positioned in proximity to the engine 12 or the inlet side of the oxidation catalyst 30 to measure or detect an inlet temperature into the oxidation catalyst 30.

Additional temperature sensors 42 detect a corresponding outlet temperature from the oxidation catalyst 30, an inlet temperature to the particulate filter 34, and an outlet temperature from the particulate filter 34. These temperature signals 11 are each transmitted by or relayed from the temperature sensors 42 to the controller 40. Controller 40 is also in communication with the engine 12 to receive feedback signals 44 that identify a variety of operating points of engine 12, such as the throttle position, engine speed, accelerator pedal position, fueling quantity, requested engine torque, among a variety of operating points.

Referring now to FIG. 2, the control system or algorithm 100 may be executed by controller 40 to evaluate the efficiency of the oxidation catalyst and to verify proper operation of the oxidation catalyst 30. In one embodiment of the disclosure, the controller 40 may evaluate the efficiency of the oxidation catalyst 30 when predetermined engine and environmental conditions are present.

Accordingly, control logic 100 may begin at entry block 102, wherein the controller executes the control logic 100 to initiate the engine light-off based diagnostic strategy for the oxidation catalyst. Controller 40 uses control system 100 to evaluate and determine the condition of the engine 12 and vehicle 10 at step or block 104 and determine if the vehicle and engine are in condition or suited for oxidation catalyst efficiency testing. In one embodiment of the disclosure, the control system or algorithm 100 may operate only upon the identification of a cold start condition by detecting the engine exhaust temperature.

While it is understood that a cold start condition may be defined by a variety of factors and conditions, for purposes of this disclosure, a cold start condition may exist where the engine off time or non-operational time is at least six (6) hours in length, the engine coolant temperature be no greater than fifty (50) degrees Celsius and/or the engine exhaust temperature be no greater than eighty (80) degrees Celsius and a requisite level of stored hydrocarbons in the oxidation catalyst. It is also understood that the control system or algorithm 100 may be disabled if the vehicle is operated in high altitude conditions and/or if the environmental temperature is at least as low as minus five (−5) degrees Celsius.

Alternatively, an exhaust warm-up calibration sequence or a small amount of post injection from the fuel injection device 36 may be used to initiate the startup procedure to increase the level of hydrocarbons stored in the oxidation catalyst 30. The post injection is input as a fixed amount of fuel and can either be used all the way to the end of an integration period described below or may be limited by a cumulative amount of hydrocarbons.

At step 106, the controller evaluates one or more operating parameters of the oxidation catalyst engine using one or more sensor disposed upstream and downstream of the oxidation catalyst 30 and in the vehicle 10. The one or more operating parameters may include, but not be limited to, the stored level of hydrocarbons (HC) in the oxidation catalyst, an exhaust gas mass flow rate upstream and downstream of the oxidation catalyst 30, the temperature upstream and downstream of the oxidation catalyst 30, the engine coolant fluid temperature and the ambient temperature of the environment in which the vehicle operates.

If the controller 40 identifies one or more operating parameters of the oxidation catalyst 30 sufficient to initiate the light-off strategy, the controller 40 initializes a temperature profile using the oxidation upstream and downstream temperature readings and to identify a thermal or temperature model 50 for an inert state of the oxidation catalyst at step 108. In one embodiment of the disclosure, control system or algorithm 100 accesses and uses a temperature model 50 stored in or accessible by controller 40 to identify an inert temperature for use by algorithm 100 that may provide an inert temperature value based upon one or more known engine and vehicle operation parameters.

At step or block 110, control system or algorithm 100 calculates a heat release value for the oxidation catalyst 30. In one embodiment of the disclosure, the heat release value may be calculated as the product of exhaust gas mass flow rate and the difference between the DOC-down temperature sensor and the inert thermal model 50 temperature. It is understood that the heat release value calculation may be aborted if the duration of integration is too short or too long as it may be difficult to recognize an exothermic hydrocarbon reaction if the acceleration is too fast. Additionally, the heat release value calculation may be aborted if the stored level of hydrocarbons in the oxidation catalyst is too high as compared to a predetermined hydrocarbon limit stored by controller 40.

At step or block 112, the value determined at step or block 110 may be used by the controller 40 to calculate the actual energy rate output from the oxidation catalyst 30. This value is integrated with respect to time, and the value stored in memory of controller 40 as represented by the following equation:

ExhaustEnergy=∫ₜ_{₁}^{t}^{₂}\dot{m}×(T_{CatDwn}−Tᵢₙₑᵣₜ)

where \dot{m} represents exhaust gas mass flow downstream of the oxidation catalyst 30, T_{catDwn} represents temperature downstream of the oxidation catalyst, Tinert represents the inert thermal model 50 temperature, ti represents a lower limit of the time interval such as a first time at which exhaust gas upstream of the oxidation catalyst reaches a first temperature, and t₂ represents an upper limit of the time interval such as a second time at which the inert thermal model temperature downstream of the oxidation catalyst reaches a second temperature that is higher than the first temperature.

The control system or algorithm 100 then proceeds to step or block 114. At step or block 114, the controller 40 obtains and determines an ideal heat release value from a calibration table and one or more correction tables stored in the memory of the controller. In one embodiment of the disclosure, the controller 40 determines the ideal heat release value based upon a curve that is a function of cumulative inlet exhaust energy at the end of integration. Corrections may be applied to the ideal heat release value based upon a number of parameters, including, but not limited to, coolant temperature and average flow rate during integration.

In one embodiment of the disclosure, the first temperature may be between about 0 degrees Celsius to about 150 degrees Celsius and the second temperature may be between about 150 degrees Celsius to about 300 degrees Celsius. The integration is concluded when the inert thermal model temperature reaches a temperature higher than the downstream oxidation catalyst temperature, which may be about 200 degrees Celsius.

At step or block 116, the control system or algorithm 100 of controller 40 uses heat release values obtained at steps 112 and 114 to calculate the overall conversion efficiency of the oxidation catalyst 30. In one embodiment of the disclosure, the control system or algorithm 100 determines oxidation catalyst efficiency by calculating a ratio of the heat release value to the ideal heat release value as represented by the equation below:

$$CatalystEfficiency = \frac{ExhaustEnergy\_Actual}{ExhaustEnergy\_Ideal}$$

The calculated efficiency is then stored in memory for use at step or block 118.

At step or block 118, the control logic or algorithm 100 identifies at least one correction or offset value to be used to calculate an oxidation catalyst output efficiency ratio. Controller 40 may obtain one or more engine or vehicle parameter measurements or values, including, but not be limited to, the engine coolant temperature and average exhaust gas flow, for use in the vehicle operation state correction offset. The control logic or algorithm 100 selects a calibration factor or value from a look-up table stored in the controller 40 based upon the relevant vehicle parameter measurements detected by the controller 40.

Based upon the readings or values obtained by controller 40 for the correction protocol or offset, the control logic or algorithm 100 applies the correction protocol or offset to the oxidation catalyst efficiency value obtained at step or block 116 to identify an oxidation catalyst output efficiency ratio at step or block 120. In one embodiment of the disclosure, the final calculated oxidation catalyst output ratio will be in a range between zero (0) and one (1). The at least one correction or offset value is used by the control logic or algorithm 100 to identify and apply a correction to the oxidation catalyst efficiency value to adjust for environmental conditions and engine conditions that may necessitate the adjustment of hydrocarbons required to generate the exotherm. The oxidation catalyst efficiency value is divided by the correction protocol or offset to generate a ratio representing the oxidation catalyst output efficiency ratio.

At step or block 122, an appropriate control action is taken by the controller 40 in response to any of the parameters or values determined or calculated in steps 102-120. For example, in one embodiment of the disclosure shown in FIGS. 3 and 4, the efficiency of the oxidation catalyst is evaluated to determine whether the catalyst should be repaired or replaced. FIG. 3 illustrates an oxidation catalyst diagnostic wherein the oxidation catalyst operates within acceptable tolerance levels and/or above a predetermine threshold level. As shown in FIG. 3, the temperature downstream of the oxidation catalyst, referenced by number 126, operates at a temperature above the inert catalyst model temperature reference by number 128.

Conversely, FIG. 4 illustrates an oxidation catalyst diagnostic wherein the oxidation catalyst operates outside of acceptable tolerance levels and/or below a predetermined threshold level that may indicate the oxidation catalyst requires repair or replacement. For example, the temperature downstream of the oxidation catalyst, referenced by number 130, operates at or near the temperature of the inert catalyst model temperature referenced by number 132. Detection of this condition by the controller may lead to the initiation of at least one control action, including, but not limited to, recording of a pass/fail diagnostic code, activation of an indicator lamp (not shown), or generation of a message, or any other action conveying the need for replacement or repair of the oxidation catalyst 30 and/or maintenance of and/or control modification to the OC system 48. Accordingly, the controller 40 calculates the oxidation catalyst conversion efficiency ratio of the oxidation catalyst 30 of the OC system 48 and completes the process at end block 124.

The controller 40 may include a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A vehicle comprising:
an engine;
an exhaust system in fluid communication with an exhaust port of the engine;
an oxidation catalyst connected with the engine via the exhaust port to receive an exhaust stream from the engine; and
a controller operable to:
determine an operating state of the vehicle,
calculate a heat release value for the oxidation catalyst,
identify an ideal heat release value,
define an oxidation catalyst efficiency value by calculating a ratio of the heat release value to the ideal heat release value,
identify at least one offset value, and
define an oxidation catalyst output efficiency ratio by calculating a ratio of the oxidation catalyst efficiency value and the at least one offset value.

2. The vehicle of claim 1 further comprising at least one sensor in communication with the controller and configured to measure the exhaust gas temperature upstream of the oxidation catalyst.

3. The vehicle of claim 1 further comprising at least one sensor in communication with the controller and configured to measure the exhaust gas temperature downstream of the oxidation catalyst.

4. The vehicle of claim 3, wherein the controller is operable to calculate the heat release value by:
determining one or more parameters of the oxidation catalyst,
determining an exhaust gas mass flow rate into the oxidation catalyst,
calculating a catalyst value from the product of the exhaust gas mass flow rate and the difference between the exhaust gas temperature downstream of the oxidation catalyst and an inert temperature, and
integrating the catalyst value to determine the heat release value.

5. The vehicle of claim 4, wherein the controller evaluates an inert catalyst temperature model to determine the inert temperature used to calculate the specific heat value of the oxidation catalyst.

6. The vehicle of claim 4, wherein the controller integrates the catalyst value wherein a lower limit of the time interval is a first time at which exhaust gas downstream of the oxidation catalyst reaches a first temperature, and an upper limit of the time interval is a second time at which exhaust gas downstream of the oxidation catalyst reaches a second temperature that is higher than the first temperature.

7. The vehicle of claim 1 wherein the controller is configured to compare the efficiency index with a preset threshold beneath which the oxidation catalyst is considered faulty.

8. The vehicle of claim 1 wherein the calibration factor for the offset value is determined from a look-up table based on an engine coolant temperature and average exhaust gas flow.

9. A system for use aboard a vehicle having an engine comprising:
an exhaust system in fluid communication with an exhaust port of the engine;
an oxidation catalyst connected with the engine via the exhaust port to receive an exhaust stream from the engine; and
a controller operable to:
determine an operating state of the vehicle,
calculate a heat release value for the oxidation catalyst,
identify an ideal heat release value,
define an oxidation catalyst efficiency value by calculating a ratio of the heat release value to the ideal heat release value,
identify at least one offset value, and
define an oxidation catalyst output efficiency ratio by calculating a ratio of the oxidation catalyst efficiency value and the at least one offset value.

10. The system of claim 9 further comprising at least one sensor in communication with the controller and configured to measure the exhaust gas temperature upstream of the diesel oxidation catalyst.

11. The system of claim 9 further comprising at least one sensor in communication with the controller and configured to measure the exhaust gas temperature downstream of the oxidation catalyst.

12. The system of claim 11, wherein the controller is operable to calculate the heat release value by:
determining one or more parameters of the oxidation catalyst,
determining an exhaust gas mass flow rate into the oxidation catalyst,
calculating a catalyst value from the product of the exhaust gas mass flow rate and the difference between the exhaust gas temperature downstream of the oxidation catalyst and an inert temperature, and
integrating the catalyst value to determine the heat release value.

13. The system of claim 12, wherein the controller evaluates an inert catalyst temperature model to determine the inert temperature used to calculate the specific heat value of the oxidation catalyst.

14. The system of claim 12, wherein the controller integrates the catalyst value wherein a lower limit of the time interval is a first time at which exhaust gas downstream of the diesel oxidation catalyst reaches a first temperature, and an upper limit of the time interval is a second time at which exhaust gas downstream of the diesel oxidation catalyst reaches a second temperature that is higher than the first temperature.

15. The system of claim 9 wherein the controller is configured to compare the efficiency index with a preset threshold beneath which the oxidation catalyst requires repair or replacement.

16. A method for determining the efficiency of an oxidation catalyst of an exhaust system aboard a vehicle in fluid communication with an exhaust port of an engine which receives an exhaust stream from the exhaust port of the engine comprising the steps of:
providing a controller in communication with the oxidation catalyst, exhaust system and engine of the vehicle;
determining an operating state of the vehicle;
calculating a heat release value with the controller for the oxidation catalyst;
identifying an ideal heat release value;
defining oxidation catalyst efficiency by calculating a ratio of the heat release value to the ideal heat release value with the controller;
identifying at least one offset value;
defining an oxidation catalyst output efficiency ratio by calculating a ratio of the oxidation catalyst efficiency value and the at least one offset value; and
executing a control action aboard the vehicle via the controller using the oxidation catalyst efficiency.

17. The method of claim 16 wherein the step of calculating a heat release value with the controller further comprises:
determining one or more parameters of the oxidation catalyst,
determining an exhaust gas mass flow rate into the oxidation catalyst;
calculating a catalyst value from the product of the exhaust gas mass flow rate and the difference between the exhaust gas temperature downstream of the oxidation catalyst and an inert temperature; and
integrating the catalyst value to determine the heat release value.

18. The method of claim 17 wherein the step of integrating the catalyst value further comprises integrating the catalyst value wherein a lower limit of the time interval is a first time at which exhaust gas downstream of the diesel oxidation catalyst reaches a first temperature, and an upper limit of the time interval is a second time at which exhaust gas downstream of the diesel oxidation catalyst reaches a second temperature that is higher than the first temperature.

19. The method of claim 16 wherein the calibration factor for the offset value is determined from a look-up table based on an engine coolant temperature and average exhaust gas flow.

20. The method of claim 16 wherein the controller compares the efficiency index with a preset threshold beneath which the oxidation catalyst is considered faulty.
